(19) United States
(12) Patent Application Publication
(10) Pub. No.: US 2026/0203489 A1
(43) Pub. Date: Jul. 16, 2026

(54) METHOD AND ELECTRONIC DEVICE FOR DESIGNING THREE-DIMENSIONAL INTEGRATED CIRCUIT

(71) Applicants: Samsung Electronics Co., Ltd., Suwon-si (KR); Georgia Tech Research Corporation, Atlanta, GA (US)

(72) Inventors: Hyeongseok JANG, Suwon-si (KR); Sungkyu LIM, Atlanta, GA (US); Junyoung HWANG, Atlanta, GA (US); Junyoung KWON, Suwon-si (KR); Sangwon KIM, Suwon-si (KR); Changseok LEE, Suwon-si (KR); Sungwoo JUNG, Atlanta, GA (US)

(73) Assignees: Samsung Electronics Co., Ltd., Suwon-si (KR); Georgia Tech Research Corporation, Atlanta, GA (US)

(21) Appl. No.: 19/445,108

(22) Filed: Jan. 9, 2026

Related U.S. Application Data
(60) Provisional application No. 63/743,777, filed on Jan. 10, 2025.

(30) Foreign Application Priority Data
Mar. 14, 2025 (KR) 10-2025-0033599

(51) Int. Cl. G06F 30/3947; G06F 30/398; G06F 119/06; G06F 119/12; H10W 20/42

(52) U.S. Cl. CPC G06F 30/3947; G06F 30/398; H10W 20/42; G06F 2119/06; G06F 2119/12

(57) ABSTRACT

Provided are a method and electronic device for designing a three-dimensional (3D) integrated circuit (IC). The method includes rearranging, for each memory array, based on a distance between the memory array and logic cells corresponding thereto, the corresponding logic cells, rearranging, for each memory array, based on a distance between the memory array and the rearranged logic cells corresponding thereto, the memory array, rearranging the vias, and rerouting one or more paths corresponding to one or more vias removed in the rearranging of the vias.

### CROSS-REFERENCE TO RELATED APPLICATIONS

This application claims the benefits of U.S. Provisional Patent Application No. 63/743,777, filed on Jan. 10, 2025, in the U.S. Patent and Trademark Office, and Korean Patent Application No. 10-2025-0033599, filed on Mar. 14, 2025, in the Korean Intellectual Property Office, the disclosures of which are incorporated herein in their entirety by reference.

### BACKGROUND

### 1. Field

The disclosure relates to a method of designing a three-dimensional (3D) integrated circuit (IC) and a 3D IC manufactured using the method.

### 2. Description of the Related Art

Research in increasing and/or maximizing efficiency in memory and logic blocks two-dimensionally to overcome physical spatial restrictions. For example, a position of memory cells may be fixed after placement of logic blocks, and the improvement and/or optimization of a route length and timing performance may be considered based on two-dimension (2D)-based design. In addition, related technologies improve connectivity between memory cells and logic blocks by using through-silicon vias (TSVs) or interposers. However, such an approach focuses on improvement of connectivity, while failing to address the constraints on the placement of memory.

### SUMMARY

Provided is a method and apparatus for designing a three-dimensional (3D) integrated circuit (IC) in which a route length and power consumption are reduced.

Additional aspects will be set forth in part in the description which follows and, in part, will be apparent from the description, or may be learned by practice of the presented embodiments of the present disclosure.

According to an aspect of the disclosure, there is provided a method of designing a three-dimensional (3D) integrated circuit (IC).

The 3D IC includes memory arrays, logic cells, and vias forming paths between the memory arrays and the logic cells, and the method includes rearranging the logic cells based on a distance between each of the memory arrays and the logic cells corresponding thereto, rearranging the memory arrays based on a distance between each of the memory arrays and the rearranged logic cells corresponding thereto, rearranging the vias, and rerouting one or more paths corresponding to one or more of the vias removed in the rearranging the vias.

In at least one embodiment, the rearranging the logic cells may include rearranging the logic cells corresponding to the memory array such that a critical path between the memory array and the logic cells corresponding to the memory array is shortened.

In at least one embodiment, the rearranging of the logic cells may include selecting, from the logic cells corresponding to each of the memory arrays, a logic cell furthest from the corresponding memory array, and changing a position of the selected logic cell to shorten a distance between the corresponding memory array and the selected logic cell.

In at least one embodiment, the rearranging the memory arrays may include rearranging the memory arrays such that a distance between at least one of the memory arrays and a centroid of the rearranged logic cells corresponding to the at least one memory array is minimized.

In at least one embodiment, the rearranging the memory arrays may include rearranging the memory arrays such that a distance between at least one of the memory arrays and a centroid of the rearranged logic cells corresponding to the at least one memory array is shortened.

In at least one embodiment, the rearranging of the vias may include rearranging the vias such that the vias are evenly distributed and removing one or more of the vias at non-permitted positions.

In at least one embodiment, the non-permitted positions may be based on a selected pitch size such that the removing of the one or more vias may include removing the one or more vias not complying with the selected pitch size.

In at least one embodiment, the rerouting the one or more paths may include selecting one or more of the vias for respective connection of the one or more corresponding paths, based on the Hungarian algorithm.

In at least one embodiment, the rerouting of the one or more paths may include selecting one or more of the vias for respective connection of the one or more corresponding paths such that a total path length of the one or more corresponding paths is minimized.

According to another aspect of the disclosure, there is provided a three-dimensional (3D) integrated circuit (IC).

The 3D IC includes a first layer including memory arrays, a second layer including logic cells, and vias forming paths between the memory arrays and the logic cells, in which at least one of the memory arrays is placed at a position determined based on positions of the at least one memory and a centroid of the logic cells corresponding to the at least one memory.

In at least one embodiment, a distance between the at least one memory array and the centroid of the logic cells corresponding to the at least one memory may be minimized.

In at least one embodiment, the distance between the at least one memory array and the centroid of the logic cells corresponding to the at least one memory may be a two-dimensional (2D) distance between the at least one memory array and the centroid of the logic cells corresponding to the at least one memory on a plane when the at least one memory array and the logic cells are projected onto the plane.

In at least one embodiment, the at least one memory array may be arranged such that a total sum of distances between each memory arrays and a centroid of logic cells corresponding thereto is minimized.

In at least one embodiment, the vias may include monolithic inter-layer vias (MIVs).

According to another aspect of the disclosure, there is provided an electronic device for designing a three-dimensional (3D) integrated circuit (IC).

The 3D IC includes memory arrays, logic cells, and vias forming paths between the memory arrays and the logic cells, and the electronic device includes a memory storing one or more instructions and one or more processors configured to execute the one or more instructions stored in the memory, in which the one or more processors are further configured, by executing the one or more instructions, to rearrange the logic cells based on a distance between each of the memory arrays and the logic cells corresponding thereto, rearrange the memory arrays based on a distance between each of the memory arrays and the rearranged logic cells corresponding thereto, rearrange the vias, and reroute one or more paths corresponding to one or more of the vias removed in the rearranging the vias.

In at least one embodiment, the one or more processors may be further configured, by executing the one or more instructions, to rearrange the logic cells corresponding to the memory array such that a critical path between the memory array and the logic cells corresponding to the memory array is shortened.

In at least one embodiment, the one or more processors may be further configured, by executing the one or more instructions, to select, from the logic cells corresponding to each of the memory arrays, a logic cell furthest from the corresponding memory array and change a position of the selected logic cell such that a distance between the corresponding memory array and the selected logic cell is shortened.

In at least one embodiment, the one or more processors may be further configured, by executing the one or more instructions, to rearrange at least one of the memory arrays to minimize a distance between the at least one memory array and a centroid of the rearranged logic cells corresponding to the at least one memory array.

In at least one embodiment, the one or more processors may be further configured, by executing the one or more instructions, to rearrange the memory arrays such that a distance between at least one of the memory arrays and a centroid of the rearranged logic cells corresponding to the at least one memory array is shortened.

In at least one embodiment, the one or more processors may be further configured, by executing the one or more instructions, to select one or more of the vias for the one or more paths based on the Hungarian algorithm.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and other aspects, features, and advantages of certain embodiments of the disclosure will be more apparent from the following description taken in conjunction with the accompanying drawings, in which:

FIG. 1 shows a layout of a two-dimensional (2D) integrated circuit (IC) according to at least one embodiment;

FIG. 2 shows a layout of a three-dimensional (3D) IC according to at least one embodiment;

FIG. 3 is a block diagram of an electronic device according to at least one embodiment;

FIGS. 4 and 5 are flowcharts of a method of designing a 3D IC according to some embodiments;

FIG. 6 shows a distance between a memory array and logic cells, according to at least one embodiment;

FIG. 7 shows a cost matrix used in a re-routing method based on a Hungarian algorithm, according to at least one embodiment;

FIGS. 8A and 8B are block diagrams of an electronic device according to some embodiments;

FIG. 9 shows a 3D IC according to at least one embodiment; and

FIGS. 10 through 12 show layouts of a 3D IC according to some embodiments.

### DETAILED DESCRIPTION

Reference will now be made in detail to embodiments, examples of which are illustrated in the accompanying drawings, wherein like reference numerals refer to like elements throughout. In this regard, the current embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

Terms used herein will be described in brief, and the disclosure will be described in detail. Throughout the disclosure, the expression “at least one of a, b or c” indicates only a, only b, only c, both a and b, both a and c, both b and c, all of a, b, and c, or variations thereof.

Although terms used in the disclosure are selected with general terms popularly used at present under the consideration of functions in the disclosure, the terms may vary according to the intention of those of ordinary skill in the art, judicial precedents, or introduction of new technology. In addition, in a specific case, the applicant may voluntarily select terms, and in this case, the meaning of the terms may be disclosed in a corresponding description part of the disclosure. Thus, the terms used in the disclosure should be defined not by the simple names of the terms but by the meaning of the terms and the contents throughout the disclosure.

It is to be understood that the singular forms include plural references unless the context clearly dictates otherwise. All terms including technical or scientific terms used herein have the same meaning as commonly understood by those of ordinary skill in the art described herein. In addition, terminology, such as ‘first’ or ‘second’ used herein, can be used to describe various components, but the components should not be limited by the terms. These terms are used to distinguish one component from another component.

Throughout the entirety of the specification of the disclosure, when it is assumed that a certain part includes a certain component, the term ‘including’ means that a corresponding component may further include other components unless specially described to the contrary. Terms used herein, such as “unit” or “module”, which indicate a unit for processing at least one function or operation, may be implemented in processing circuitry, such as hardware, software, or in a combination of hardware and software. For example, the processing circuitry more specifically may include (and/or be included in), but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

In the disclosure, a ‘logic cell’may mean a circuit that performs a logic operation.

In the disclosure, a ‘memory array’ may mean a data storage device including one or more memory cells.

Hereinafter, embodiments of the disclosure will be described in detail with reference to the attached drawings to allow those of ordinary skill in the art to easily carry out the embodiments of the disclosure. However, the disclosure may be implemented in various forms, and are not limited to the embodiments of the disclosure described herein.

Hereinafter, various embodiments of the disclosure will be described with reference to the accompanying drawings.

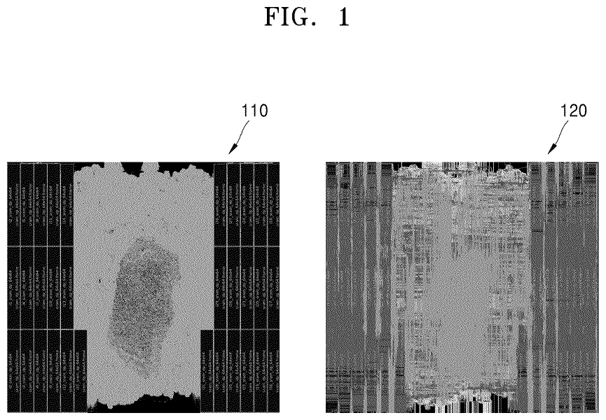

FIG. 1 shows a layout of a two-dimensional (2D) integrated circuit (IC) according to at least one embodiment.

A left view 110 shows a layout of logic cells and memory arrays of the 2D IC. A right view 120 shows a routing layout of the 2D IC. In the 2D IC, the logic cells and the memory arrays are placed in one layer. In the 2D IC, the logic cells and the memory arrays are routed in one layer.

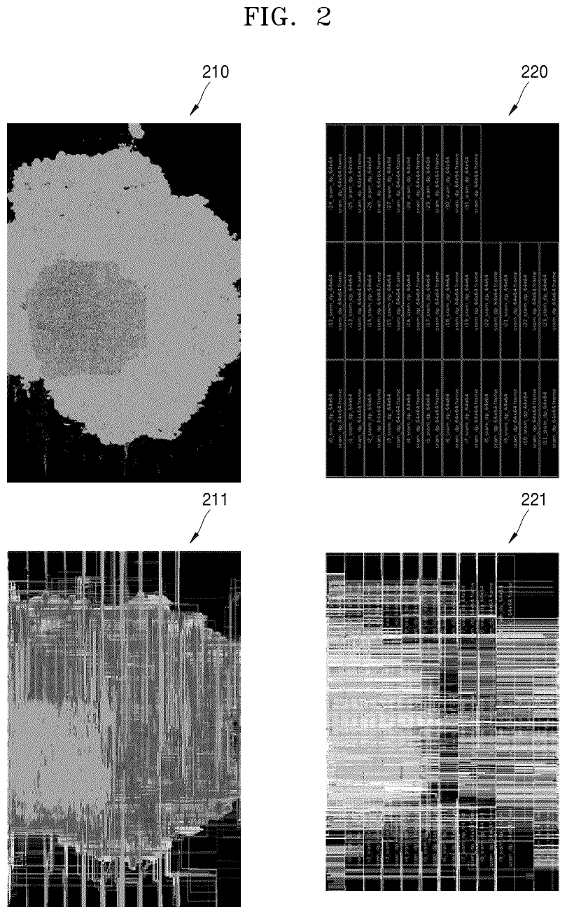

FIG. 2 shows a layout of a three-dimensional (3D) IC according to at least one embodiment.

An upper left view 210 shows a layout of a first layer in which logic cells of the 3D IC are placed. In the upper left view 210, each dot indicates a logic cell. An upper right view 220 shows a layout of a second layer in which memory arrays of the 3D IC are placed. In the upper right view 220, each rectangle indicates a memory array. A lower left view 211 shows a routing layout of the first layer. A lower right view 221 shows a routing layout of the second layer.

In comparison to the 2D IC, the 3D IC may be manufactured by stacking two or more layers (or dies or tiers) and thus may perform the same function with a smaller area. In the 3D IC, when compared to in the 2D IC, a distance between the logic cells and the memory arrays may decrease, providing improved performance in terms of power consumption and signal delay.

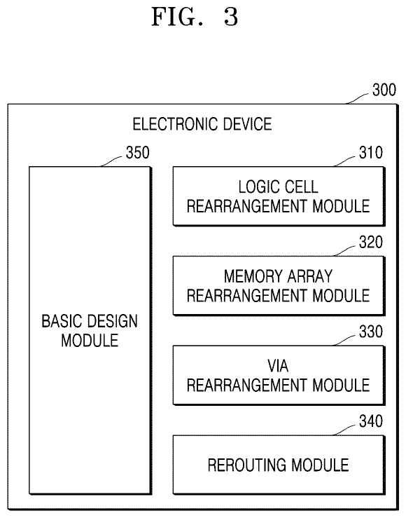

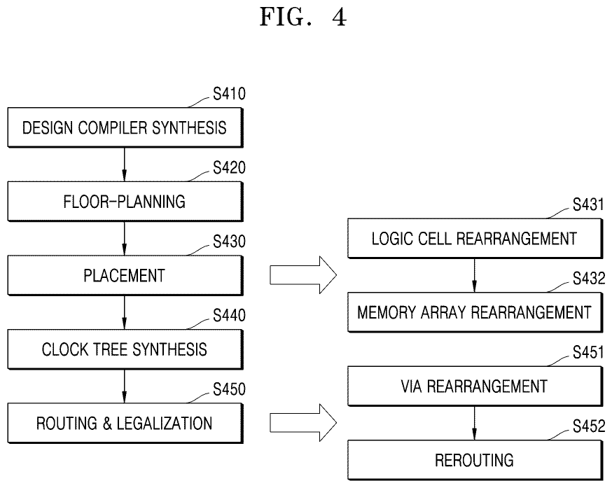

FIG. 3 is a block diagram of an electronic device 300 according to at least one embodiment. FIG. 4 is a flowchart of a method of designing a 3D IC according to some embodiments.
The electronic device 300 may be configured to design the 3D IC. The electronic device 300 may include electronic design automation (EDA) tools for designing the 3D IC. The electronic device 300 may be provided with a design Register Transfer Level (RTL), design constraints, a technology library, and/or the like.
In at least one embodiment, the electronic device 300 may include a logic cell rearrangement module 310, a memory array rearrangement module 320, a via rearrangement module 330, a rerouting module 340, and/or a basic design module 350. Any or all of the elements described with reference to the figures may communicate with any or all other elements described with reference to the figures. For example, any element of the electronic device 300 (e.g., a logic cell rearrangement module 310, a memory array rearrangement module 320, a via rearrangement module 330, a rerouting module 340, and/or a basic design module 350) may engage in one-way and/or two-way and/or broadcast communication with any or all other elements in the electronic device 300, to transfer and/or exchange and/or receive information such as but not limited to data and/or commands, in a manner such as in a serial and/or parallel manner, via a bus such as a wireless and/or a wired bus (not illustrated). The information may be encoded in various formats, such as in an analog format and/or in a digital format.

The modules 310 to 350 shown in FIG. 3 may be components implemented by processing circuitry, such as at least one processor included in the electronic device 300 executing a program or an instruction stored in a memory included in the electronic device 300. Thus, operations described as being performed by the modules 310 to 350 of the electronic device 300 may be performed by at least one processor included in the electronic device 300.

Referring to FIGS. 3 and 4 together, the basic design module 350 may perform digital circuit design by using the EDA tools. In at least one embodiment, the basic design module 350 may perform design compiler synthesis in operation S410, perform floor-planning in operation S420, perform placement in operation S430, perform clock tree synthesis in operation S440, and perform routing and legalization in operation S450.

Upon completion of placement in operation S430, initial positions of the logic cells and the memory arrays may be determined. In operation S431, the logic cell rearrangement module 310 may rearrange the logic cells based on the initial positions of the logic cells and the memory arrays. In operation S432, the memory array rearrangement module 320 may rearrange the memory arrays based on the positions of the rearranged logic cells.

Upon completion of legalization on the logic cells in operation S450, the via rearrangement module 330 may rearrange vias in operation S451. In a via rearrangement process, the via rearrangement module 330 may remove the vias at non-permitted positions. In operation S452, the rerouting module 340 may reroute paths corresponding to the removed vias.

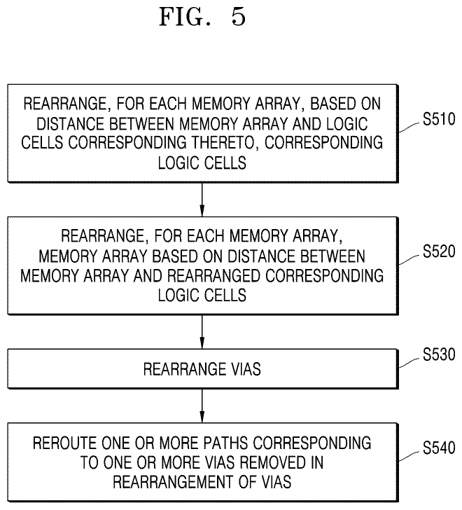

Operations S431, S432, S451, and S452 will be described in detail with reference to FIG. 5.

FIG. 5 is a flowchart of a method of designing a 3D IC according to some embodiments.

The 3D IC may include the first layer where the logic cells (or logic dies or logic tiers) are placed, the second layer where the memory arrays (or memory dies or memory tiers) are placed, and the vias forming paths between the logic cells and the memory arrays. Herein, the vias may be (or include) monolithic inter-layer vias (MIVs).

Referring to FIGS. 3 and 5, in operation S510, the logic cell rearrangement module 310 may rearrange corresponding logic cells (e.g., corresponding to each memory array) based on a distance between logic cells corresponding to the memory array. Herein, the corresponding logic cells may mean the logic cells connected to the corresponding memory array. In at least one example, the corresponding logic cells may be determined from a netlist.

The logic cell rearrangement module 310 may obtain an initial placement for the logic cells and the memory arrays, e.g., from the basic design module 350. The logic cell rearrangement module 310 may obtain (or determine) a critical path between the logic cells corresponding to the memory array based on the initial placement. For example, the logic cell rearrangement module 310 may obtain the critical path by obtaining the length of the longest interconnection among interconnections connected to the memory array. The logic cell rearrangement module 310 may rearrange the corresponding logic cells to shorten the critical path. In this way, the logic cell rearrangement module 310 may rearrange the corresponding logic cells to shorten the critical path for each memory array.

Shortening the critical path may mean reducing the length of the critical path to shorten the delay time of the critical path and/or may mean reducing the length of the critical path.

The logic cell rearrangement module 310 may select, from among the corresponding logic cells, a logic cell that is furthest from the memory array. The logic cell rearrangement module 310 may change a position of the furthest logic cell to shorten a distance between the memory array and the furthest logic cell. For example, the logic cell rearrangement module 310 may move the furthest logic cell in a direction close to the memory array. In this way, the logic cell rearrangement module 310 may rearrange the corresponding logic cells for each memory array to shorten the distance between the memory array and the furthest logic cell.

In operation S520, for each memory array, the memory array rearrangement module 320 may rearrange the memory array based on a distance between the memory array and the rearranged logic cells corresponding thereto.

The memory array rearrangement module 320 may rearrange the memory array such that the memory array is closer to the rearranged corresponding logic cells. Herein, the distance between the memory array and the rearranged logic cells corresponding thereto may mean a distance between the memory array and a centroid of the rearranged corresponding logic cells.

In at least one embodiment, the memory array rearrangement module 320 may rearrange the memory array to minimize the distance between the memory array and the centroid of the rearranged corresponding logic cells.

In at least one embodiment, the memory array rearrangement module 320 may rearrange each memory array to minimize a sum (or a total sum) of the distances between the memory array and the centroid of the rearranged corresponding logic cells. For example, the memory array rearrangement module 320 may rearrange memory arrays in various ways to calculate a total distance sum corresponding to each rearrangement and select rearrangement having the minimum total distance sum.

In operation S530, the via rearrangement module 330 may rearrange the vias.

The via rearrangement module 330 may rearrange the vias to protect against the vias from being crowded. The via rearrangement module 330 may rearrange the crowded vias such that the crowded vias may be evenly distributed. In at least one embodiment, the via rearrangement module 330 may evenly rearrange the vias such that a density of the vias is less than or equal to a selected value. In at least one embodiment, the via rearrangement module 330 may evenly rearrange the vias such that the density of the vias is constant (e.g., evenly distributed).

A through silicon via (TSV) may be difficult to rearrange due to a size and a physical structure thereof. When compared to the TSV, the MIV may be more freely placed, such that the via rearrangement module 330 may be placed such that the vias may be evenly distributed. As such, in at least one embodiment, the vias rearranged by the via rearrangement module 330 may be the MIV arrangement.

The via rearrangement module 330 may remove one or more vias at non-permitted positions in the via rearrangement process. Herein, the non-permitted positions may include positions not permitted in a manufacturing process such as a position at which interconnection conflict occurs, a position at which a selected pitch size is not complied with, a position at which design constraints are not satisfied, etc.

In operation S540, the rerouting module 340 may reroute one or more paths corresponding to the one or more vias removed in the via rearrangement process. Herein, the corresponding one or more paths may mean paths to which the removed one or more vias are allocated.

The rerouting module 340 may reroute the corresponding one or more paths by allocating each path to the via. For better and/or optimal allocation, the rerouting module 340 may select the vias for connection of each of the corresponding one or more paths based on a combinatorial optimization algorithm, such as the Hungarian algorithm (also referred to as the Kuhn-Munkres algorithm).

In at least one embodiment, the rerouting module 340 may select the one or more vias for connection of each of the corresponding one or more paths to reduce and/or minimize a total path length of the corresponding one or more paths.

In at least one embodiment, the rerouting module 340 may select the one or more vias for connection of each of the corresponding one or more paths to reduce and/or minimize a path length of each path.

Thereafter, the 3D IC designed by the above method may be produced and/or assembled by a semiconductor device facility and/or apparatus. For example, the semiconductor device facility and/or apparatus may be configured to produce the 3D IC based on the design for the 3D IC, and may be configured to physically arrange the memory arrays, logic cells, paths, and/or vias based on the design. In at least some embodiments, the semiconductor device facility and/or apparatus may include the electric device 300 of FIG. 3. For example, the electric device 300 may be included in processing circuitry configured to control the assembly operations of the semiconductor device facility and/or apparatus Through rearrangement of the logic cells and the memory arrays, a sum of a total distance between each memory array and corresponding logic cells may be shortened. A path length may be shortened through rerouting. As an interconnection length decreases, power consumption and data transmission delay may decrease and spatial efficiency and data transmission accuracy may be improved.

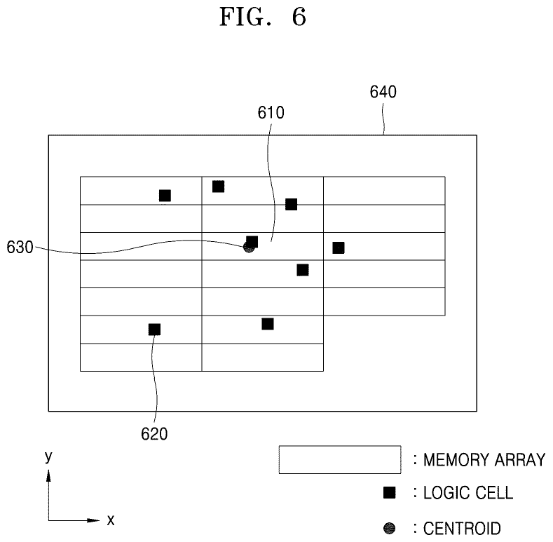

FIG. 6 shows a distance between a memory array and logic cells according to at least one embodiment.

Based on a distance between a memory array and corresponding logic cells, the corresponding logic cells may be rearranged. Based on the distance between the memory array and the rearranged corresponding logic cells, the memory array may be rearranged. Herein, the distance between the memory array and the corresponding logic cells (or the rearranged logic cells) may mean a 2D distance on a plane when the memory array and the corresponding logic cells (or the rearranged logic cells) are projected to the plane. Herein, the plane may be a plane parallel with layers (or dies or tiers) of the 3D IC.

FIG. 6 shows an example view of memory arrays and logic cells (or rearranged logic cells) projected onto a plane 640. In FIG. 6, rectangular points indicate logic cells corresponding to a memory array 610. In FIG. 6, a circular point indicates a centroid 630 of the corresponding logic cells.

In at least one embodiment, a distance between the memory array 610 and the corresponding logic cells may be a 2D distance between the memory array 610 and the corresponding logic cells on a plane 640. In at least one embodiment, a logic cell 620 furthest from the memory array 610 among the logic cells may be furthest from the memory array 610 on the plane 640. In at least one embodiment, a distance between the memory array 610 and the centroid 630 of the logic cells may be a 2D distance between the memory array 610 and the centroid 630 of the logic cells on the plane 640.

In at least one embodiment, the centroid of the logic cells may be calculated from an average of x coordinates and an average of y coordinates of the logic cells. When a weight is given to specific logic cells, the centroid of the logic cells may be calculated from a weighted average of x coordinates and a weighted average of y coordinates of the logic cells.

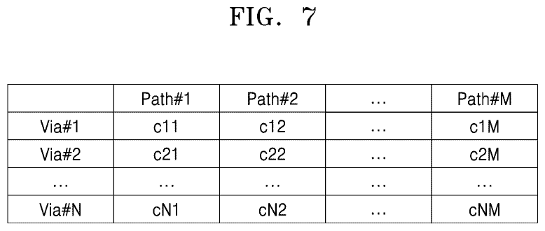

FIG. 7 shows a cost matrix used in a re-routing method based on a Hungarian algorithm according to at least one embodiment.

To reroute paths corresponding to the vias removed in the via rearrangement process, a Hungarian algorithm may be used. By using the Hungarian algorithm, the corresponding paths may be rerouted to the remaining vias to set an optimal path between the memory arrays and the logic cells.

FIG. 7 shows an example cost matrix of a Hungarian algorithm for allocating M paths corresponding to removed vias to N vias. In the cost matrix, cxy indicates a cost when a y^{th} path is allocated to an x^{th} via. Herein, the cost may be a path length or a path delay when the y^{th} path is allocated to the x^{th} via. Based on the Hungarian algorithm, the M paths may be allocated to the N vias to minimize a total cost.

In at least one embodiment, a cost matrix of a Hungarian algorithm may be generated by adding a dummy row or a dummy column.

In at least one embodiment, when L paths are allocatable to a specific via, the specific via may be arranged in L rows of the cost matrix.

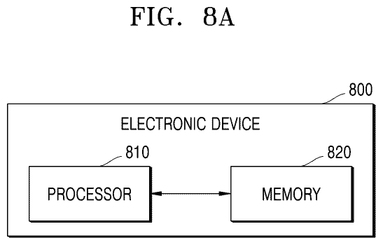

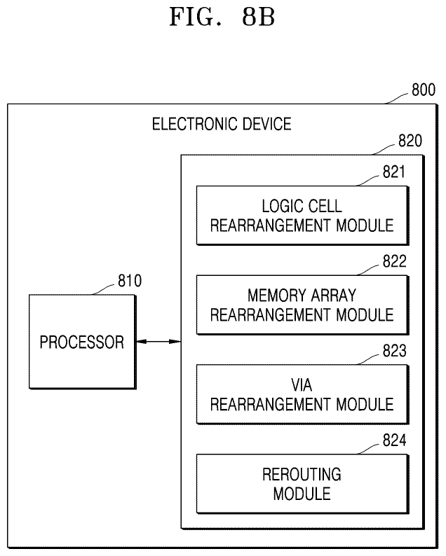

FIGS. 8A and 8B are block diagrams of an electronic device according to some embodiments.

FIG. 8A is a block diagram of an electronic device 800 according to at least one embodiment.

The electronic device 800 may include a processor 810 and a memory 820. The processor 810 and the memory 820 may be configured to communicate with each other through a bus.

The processor 810 may control overall operations of the electronic device 800. Fo example, the processor 810 may execute one or more instructions of the program stored in the memory 820 such that the electronic device 800 may control overall operations for designing a 3D IC. For example, the processor 810 may control, by executing the one or more instructions of the program stored in the memory 820, overall operations for causing the electronic device 800 to, for each memory array, rearrange logic cells corresponding to the memory array based on a distance between the memory array and the corresponding logic cells, rearrange, for each memory array, the memory array based on a distance between the memory array and the rearranged logic cells corresponding thereto, and reroute one or more paths corresponding to one or more vias removed in a via rearrangement process. One or more processors 810 may be provided.

The one or more processors 810 may include, but are not limited to, for example, a CPU, a microprocessor, a GPU, application specific integrated circuits (ASICs), digital signal processors (DSPs), digital signal processing devices (DSPDs), programmable logic devices (PLDs), field programmable gate arrays (FPGAs), an application processor, a neural processing unit (NPU), an artificial intelligence dedicated processor designed as a hardware structure specialized for processing of an artificial intelligence model, and/or the like.

The memory 820 may store instructions, data structures, and program codes which are readable by the processor 810. Operations performed by the processor 810 may be implemented by executing instructions or codes of the program stored in the memory 820,

The memory 820 may include a memory of a flash memory type, a hard disk type, a multimedia card micro type, a card type (e.g., an SD or XD memory), etc., a non-volatile memory including at least one of read-only memory (ROM), electrically erasable programmable ROM (EEPROM), programmable ROM (PROM), a magnetic memory, a magnetic disk, or an optical disk, and a volatile memory such as random access memory (RAM) or static RAM (SRAM).

The memory 820 may store one or more instructions and/or program for causing the electronic device 800 to design the 3D IC. The memory 820 may store one or more instructions and/or program for causing the electronic device 800 to design the 3D IC.

FIG. 8B is a block diagram of the electronic device 800 according to at least one embodiment.

In a description of FIG. 8B, a matter redundant to the description of FIG. 8A will be omitted for brevity.

In at least one embodiment, instructions and/or programs for implementing functions of the logic cell rearrangement module 821, the memory array rearrangement module 822, the via rearrangement module 823, and the rerouting module 824 may be stored in the memory 820. A basic design module may be further stored in the memory 820.

The logic cell rearrangement module 821, the memory array rearrangement module 822, the via rearrangement module 823, and the rerouting module 824 may be executed by the processor 810. A description of operations of each of the modules is already provided in a description of previous drawings, and thus a redundant description will be omitted.

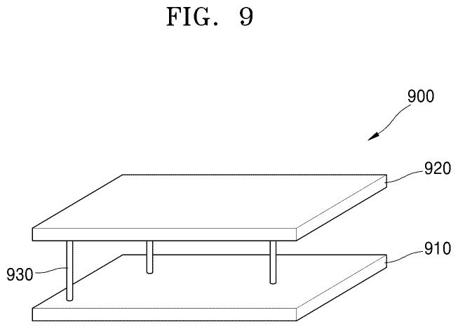

FIG. 9 shows a 3D IC 900 according to at least one embodiment.

The 3D IC 900 may be designed and manufactured using a method of designing a 3D IC according to some embodiments. The 3D IC 900 may include a first layer 910 in which memory arrays are rearranged, a second layer 920 in which logic cells are rearranged, and vias 930 for forming paths between the memory arrays and the logic cells. The 3D IC 900 may further include other components than those shown in FIG. 9.

In the first layer 910, at least one memory array may be placed at a position determined based on a position of a centroid of logic cells corresponding to at least one memory array.

In at least one embodiment, the at least one memory array may be placed to minimize the distance between the at least one memory array and a centroid of logic cells corresponding to the at least one memory array. In other words, the at least one memory array may be arranged at a position closest to the centroid of the corresponding logic cells. Herein, the distance between the at least one memory array and the centroid of the corresponding logic cells may be a 2D distance between the at least one memory array and the centroid of the corresponding logic cells on a plane when the at least one memory array and the corresponding logic cells are projected onto the plane.

In at least one embodiment, the memory arrays may be placed such that a total distance sum between the memory arrays and the centroid of corresponding logic cells is reduced and/or minimized. That is, the memory arrays of the first layer 910 may be placed such that a total distance sum between each memory array and a centroid of corresponding logic cells is at a minimum.

A method of designing a 3D IC according to some embodiments may be applied to various fields such as a mobile device like a smart phone, a tablet, etc., an artificial intelligence system, a machine learning system, a data center, a cloud computer, an autonomous vehicle, a medical device, an aerospace system, a defense system, Internet of Things (IoT), etc. The 3D IC 900 may be mounted on an electronic device of various applications.

As the 3D IC 900 may be designed to shorten a path and reduce path complexity, data transmission delay and power consumption are reduced, thereby providing overall improved performance. Through mounting on the electronic device of various applications, superior performance may be provided with high data transmission speed and low power.

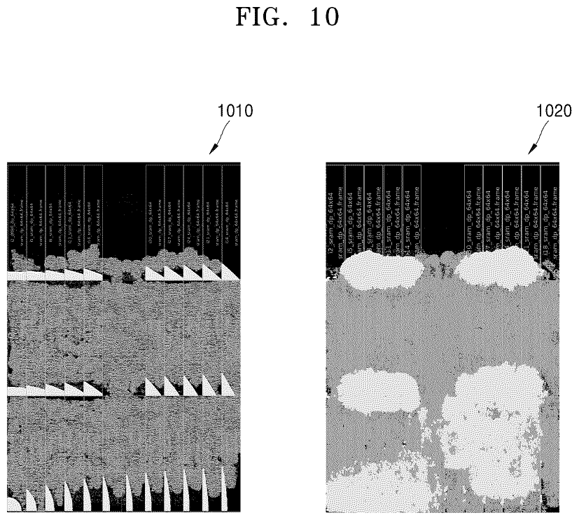

FIGS. 10 through 12 show layouts of a 3D IC according to some embodiments.

FIG. 10 shows overlapping layouts of logic cells and memory arrays. A left view 1010 shows a layout before rearrangement of the logic cells, and a right view 1020 shows a layout after rearrangement of the logic cells. In the left view 1010 and the right view 1020, each yellow dot indicates a logic cell corresponding to a memory array. Through rearrangement of the corresponding logic cells, a maximum distance between the memory array and the corresponding logic cells may be shortened. The power consumption and the data transmission delay may be reduced due to distance shortening.

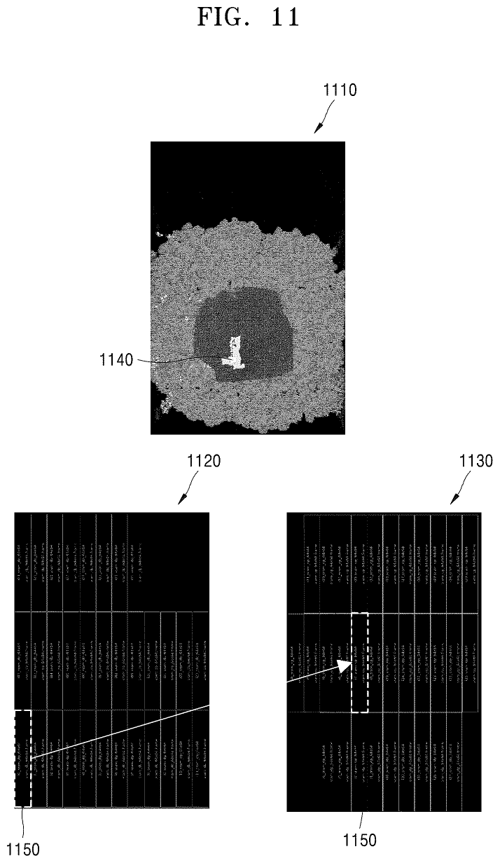

In FIG. 11, an upper view 1110 shows a layout of rearranged logic cells. A lower left view 1120 shows a layout before rearrangement of a memory array 1150, and a lower right view 1130 shows a layout after rearrangement of the memory array 1150. In the upper view 1110, each yellow dot indicates a logic cell corresponding to the memory array 1150. In the upper view 1110, a centroid 1140 of corresponding logic cells is shown. Through rearrangement of the memory array 1150, a distance between the memory array 1150 and the centroid 1140 of the corresponding logic cells may be shortened. By reducing the interconnection length, power consumption and data transmission delay may decrease and spatial efficiency and data transmission accuracy may be improved.

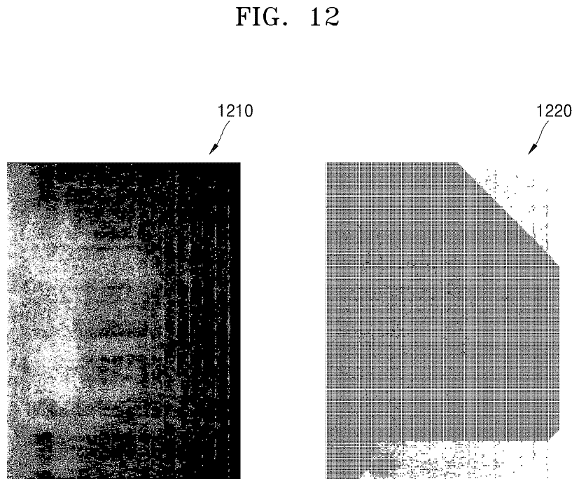

In FIG. 12, a left view 1210 shows a layout before rearrangement of the vias, and a right view 1220 shows a layout after rearrangement of the vias. In the left view 1210 and the right view 1220, each rectangle indicates a via. As the crowded vias are rearranged to be evenly distributed, path complexity may be reduced, thereby minimizing data transmission delay.

At least one embodiment of the disclosure may be implemented using a recording medium including a computer-executable command such as a computer-executable programming module. The computer-readable recording medium may be an available medium that is accessible by a computer, and includes all of a volatile medium, a non-volatile medium, a separated medium, and a non-separated medium. The computer-readable recording medium may also include a computer storage medium and a communication medium. The computer storage medium includes all of a volatile medium, a non-volatile medium, a separated medium, and a non-separated medium, which is implemented by a method or technique for storing information such as a computer-readable instruction, a data structure, a programming module, or other data. A communication medium may typically include a computer-readable instruction, a data structure, or other data of a modulated data signal such as a programming module.

The computer-readable storage medium may be provided in the form of a non-transitory storage medium. Herein, the term ‘non-transitory storage medium’ simply means that the storage medium is a tangible device, and does not include a signal (e.g., an electromagnetic wave), but this term does not differentiate between where data is semi-permanently stored in the storage medium and where the data is temporarily stored in the storage medium. For example, the ‘non-transitory storage medium’ may include a buffer storing data temporarily.

According to at least one embodiment, a method according to various embodiments disclosed herein may be included and provided in a computer program product. The computer program product may be traded as a product between a seller and a buyer. The computer program product may be distributed in the form of a machine-readable storage medium (e.g., a compact disc read only memory (CD-ROM)), or be electronically distributed (e.g., downloaded or uploaded) via an application store or directly between two user devices (e.g., smartphones). When distributed online, at least a part of the computer program product (e.g., a downloadable app) may be temporarily generated or at least temporarily stored in the machine-readable storage medium, such as memory of the manufacturer's server, a server of the application store, or a relay server.

Those of ordinary skill in the art to which the disclosure pertains will appreciate that the disclosure may be implemented in different detailed ways without departing from the technical spirit or essential characteristics of the disclosure. Accordingly, the aforementioned embodiments should be construed as being only illustrative, but should not be constructed as being restrictive from all aspects. For example, each element described as a single type may be implemented in a distributed manner, and likewise, elements described as being distributed may be implemented as a coupled type.

The scope of the disclosure is defined by the following claims rather than the detailed description, and the meanings and scope of the claims and all changes or modified forms derived from their equivalents should be construed as falling within the scope of the disclosure.

It should be understood that the embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A method of designing a three-dimensional (3D) integrated circuit (IC),
wherein the 3D IC comprises memory arrays, logic cells, and vias forming paths between the memory arrays and the logic cells, the method comprising:
rearranging the logic cells based on a distance between each of the memory arrays and the logic cells corresponding thereto;
rearranging the memory arrays based on a distance between each of the memory arrays and the rearranged logic cells corresponding thereto;
rearranging the vias; and
rerouting one or more paths corresponding to one or more of the vias removed in the rearranging the vias.

2. The method of claim 1, wherein the rearranging the logic cells comprises rearranging the logic cells corresponding to the memory array such that a critical path between the memory array and the logic cells corresponding to the memory array is shortened.

3. The method of claim 1, wherein the rearranging the logic cells comprises:
selecting, from the logic cells corresponding to each of the memory arrays, a logic cell furthest from the corresponding memory array; and
changing a position of the selected logic cell to shorten a distance between the corresponding memory array and the selected logic cell.

4. The method of claim 1, wherein the rearranging the memory arrays comprises rearranging the memory arrays such that a distance between at least one of the memory arrays and a centroid of the rearranged logic cells corresponding to the at least one memory array is minimized.

5. The method of claim 1, wherein the rearranging the memory arrays comprises rearranging the memory arrays such that a distance between at least one of the memory arrays and a centroid of the rearranged logic cells corresponding to the at least one memory array is shortened.

6. The method of claim 1, wherein the rearranging of the vias comprises:
rearranging the vias such that the vias are evenly distributed; and
removing one or more of the vias at non-permitted positions.

7. The method of claim 6, wherein the non-permitted positions are based on a selected pitch size such that the removing of the one or more vias comprises removing the one or more vias not complying with the selected pitch size.

8. The method of claim 1, wherein the rerouting the one or more paths comprises selecting one or more vias for respective connection of the one or more paths based on the Hungarian algorithm.

9. The method of claim 1, wherein the rerouting the one or more paths comprises selecting one or more of the vias for respective connection of the one or more paths such that a total path length of the one or more paths is minimized.

10. A three-dimensional (3D) integrated circuit (IC) comprising:
a first layer including memory arrays;
a second layer including logic cells; and
vias forming paths between the memory arrays and the logic cells,
wherein at least one memory array of the memory arrays is located at a position determined based on a position of a centroid of the logic cells corresponding to the at least one memory.

11. The 3D IC of claim 10, wherein a distance between the at least one memory array and the centroid of the logic cells corresponding to the at least one memory is minimized.

12. The 3D IC of claim 11, wherein the distance between the at least one memory array and the centroid of the logic cells corresponding to the at least one memory is a two-dimensional (2D) distance between the at least one memory array and the centroid of the logic cells corresponding to the at least one memory on a plane when the at least one memory array and the logic cells are projected onto the plane.

13. The 3D IC of claim 10, wherein the at least one memory array is arranged such that a total sum of distances between each memory arrays and a centroid of logic cells corresponding thereto is minimized.

14. The 3D IC of claim 10, wherein the vias include monolithic inter-layer vias (MIVs).

15. An electronic device for designing a three-dimensional (3D) integrated circuit (IC), wherein the 3D IC comprises memory arrays, logic cells, and vias forming paths between the memory arrays and the logic cells, the electronic device comprising:
a memory storing one or more instructions; and
one or more processors configured to execute the one or more instructions stored in the memory,
wherein the one or more processors are further configured, by executing the one or more instructions, to
rearrange the logic cells based on a distance between each of the memory arrays and the logic cells corresponding thereto,
rearrange the memory arrays based on a distance between each of the memory arrays and the rearranged logic cells corresponding thereto,
rearrange the vias, and
reroute one or more paths corresponding to one or more of the vias removed in the rearranging the vias.

16. The electronic device of claim 15, wherein the one or more processors are further configured, by executing the one or more instructions, to rearrange the logic cells corresponding to the memory array such that a critical path between the memory array and the logic cells corresponding to the memory array is shortened.

17. The electronic device of claim 15, wherein the one or more processors are further configured, by executing the one or more instructions, to:
select, from the logic cells corresponding to each of the memory arrays, a logic cell furthest from the corresponding memory array; and
change a position of the selected logic cell such that a distance between the corresponding memory array and the selected logic cell is shortened.

18. The electronic device of claim 15, wherein the one or more processors are further configured, by executing the one or more instructions, to rearrange the memory arrays to minimize a distance between at least one of the memory arrays and a centroid of the rearranged logic cells corresponding to the at least one memory array.

19. The electronic device of claim 15, wherein the one or more processors are further configured, by executing the one or more instructions, to rearrange the memory arrays such that a distance between at least one of the memory arrays and a centroid of the rearranged logic cells corresponding to the at least one memory array is shortened.

20. The electronic device of claim 15, wherein the one or more processors are further configured, by executing the one or more instructions, to select one or more of the vias for the one or more paths based on the Hungarian algorithm.
